(19) United States
(12) Patent Application Publication
(10) Pub. No.: US 2020/0307153 A1
(43) Pub. Date: Oct. 1, 2020

(54) FIBER REINFORCED COMPOSITE STRUCTURE COMPRISING STITCH-MEMBER AND THE METHOD FOR PRODUCING THE SAME

(71) Applicant: KOREA INSTITUTE OF SCIENCE AND TECHNOLOGY, Seoul (KR)

(72) Inventors: Jaesang YU, Jeollabuk-do (KR); Hyunkee HONG, Jeollabuk-do (KR); Kwak Jin BAE, Jeollabuk-do (KR); Hana JUNG, Jeollabuk-do (KR); Hoi-Kil CHOI, Jeollabuk-do (KR); Yuna OH, Jeollabuk-do (KR); Dong Won LEE, Jeollabuk-do (KR); Cheol-Min YANG, Jeollabuk-do (KR); Min Wook LEE, Jeollabuk-do (KR); Minkook KIM, Jeollabuk-do (KR); Wonjin NA, Jeollabuk-do (KR); Nam Ho YOU, Jeollabuk-do (KR)

(21) Appl. No.: 16/802,557

(22) Filed: Feb. 27, 2020

(30) Foreign Application Priority Data
Mar. 28, 2019 (KR) 10-2019-0035997

(51) Int. Cl. B32B 7/09; B29C 70/54

(52) U.S. Cl. CPC B32B 7/09; B29C 70/54; B29K 2105/0881; B32B 2307/302; B32B 2262/106

(57) ABSTRACT

The present specification provides a carbon fiber reinforced composite structure comprising: a plurality of carbon fiber reinforced sheets, which are laminated; and a stitch member penetrating one or more carbon fiber reinforced sheets, in which the carbon fiber reinforced sheet includes a plurality of reinforcing carbon fibers arranged in one direction. The carbon fiber reinforced composite structure shows excellent thermal conductivity in a thickness direction.

### DESCRIPTION ABOUT NATIONAL SUPPORT RESEARCH AND DEVELOPMENT

This study was supported by following national research projects:

Ministry of Trade, Industry and Energy, Republic of Korea (Development of aircraft reinforcement panel and “C” and “Z” channel using carbon fiber UD Tape with PPS and PEEK fiber content of 60 wt % or more, Project No. 1415158981) under the superintendence of Kolon Plastics Co., Ltd,

Ministry of Science and ICT, Republic of Korea (Development of current/heat conducting carbon fiber reinforced composite material manufacturing technology, Project No. 1711082003) under the superintendence of Korea Institute of Science and Technology.

### CROSS-REFERENCE TO RELATED APPLICATION

This application claims priority to Korean Patent Application No. 10-2019-0035997, filed on Mar. 28, 2019, and all the benefits accruing therefrom under 35 U.S.C. § 119, the contents of which in its entirety are herein incorporated by reference.

### BACKGROUND OF THE INVENTION

### Field of the Invention

This disclosure relates to a fiber composite structure and a method for producing the same, and more particularly, to a fiber reinforced composite structure with improved thermal conductivity in a stacking direction, while having excellent mechanical strength.

### Description of the Related Art

Currently, the demand for carbon fiber reinforced polymer (CFRP) composite materials has been gradually increasing in various fields such as the aerospace, automotive, sports and leisure industries. Currently, from the viewpoint of the automotive part materials market, carbon fiber reinforced composite materials are used for about 50% of structural parts in the BMW i3 series and the like for the purpose of reducing carbon dioxide and improving fuel efficiency. In particular, the sales ratio of carbon fiber used for aerospace is found to be about 40% of the total sales ratio, which is the highest, and it is understood that the sales ratio corresponds to the demand for high performance and high functionality materials. In the aviation field, not only in fighters, but also in commercial aircraft A380 (Airbus) and B787 (Boeing), composite materials with good ratio of rigidity have been actively used for 20 to 50% parts of the entire structure. However, in the satellite industry, the composite materials have been limitedly used only for simple structures such as solar cell panels and mounted connection structures. The reason is that highly heat-generating electrical components used in satellites need to be confined in the narrow internal space of a sandwich platform surrounded by plate-like parts, and a restriction occurs in terms of service life or management when the heat generated by mechanical driving is not smoothly released. In this case, when a carbon fiber composite material plate-like structure is used, heat will not be released due to the characteristics of the carbon fiber composite material that cannot conduct heat well in a thickness direction. Since currently widely used unidirectional or biaxial composite material laminates have excellent heat conductivity in a planar direction, but have very low heat conductivity in a thickness direction, carbon fiber reinforced composite materials that also conduct heat well in the thickness direction need to be developed and studied in order to be used as components and internal structures of an artificial satellite.

A pitch-based carbon fiber having a high elastic modulus (about 900 GPa), a high thermal conductivity (about 900 W/mK), and a low coefficient of thermal expansion is usually used as a carbon fiber composite material used for space rockets and artificial satellites. However, a PAN-based carbon fiber has a tensile strength (about 6400 MPa) about 1.5 times that of the pitch-based carbon fiber. When an artificial satellite platform is composed of a pitch-based carbon fiber composite material, the artificial satellite platform may have high elastic modulus and good thermal conductivity, but the strength is not relatively high, and when a carbon fiber composite material is only composed of PAN-based material, heat trapped in a very low thermal conductivity will cause damage to electrical components.

Thus, there is an increasing need for carbon fiber composite materials having higher tensile strength and higher thermal conductivity in a thickness direction than existing carbon fiber composite materials.

As a study on the conductivity in a thickness direction, there are several inventions that increase the conductivity in a thickness direction by inserting and penetrating fibers and the like in a thickness direction in addition to a carbon fiber composite material laminate. Korean Patent Application No. 10-2016-0067262 presents an invention for a new production process for producing a three-dimensional carbon fiber fabric by allowing carbon fibers to penetrate a two-dimensional web using needle punching, US 2016/0347918 A1 presents an invention for a carbon fiber composite material having electrical conductivity in a thickness direction, which may be applied to an aircraft, by devising a form of, when a plate-like carbon fiber composite material is laminated, making vertical creases, or surrounding a middle layer by an upper layer and a lower layer, and a lamination method in which the uppermost layer surrounds the outer edge parts of lower layers or fixing various layers with conductive metal nails, and US 2010/0021682 A1 presents an invention for increasing thermal conductivity of glass fiber composite material by stitching CNT fibers, copper wires, and the like by about 5% as compared to the total volume of a glass fiber composite material (control group).

### CITATION LIST

### Patent Literature

Patent Literature 1: KR 10-2017-0135399 A1

Patent Literature 2: US 2016/0347918 A1.

Patent Literature 3: US 2010/0021682 A1.

### SUMMARY OF THE INVENTION

As described above, embodiments of the present invention have been made in an effort to solve a problem of low thermal conductivity in the thickness direction of a unidirectional or biaxial composite laminate.

Further, embodiments of the present invention have been made in an effort to solve a problem that existing composite materials selectively have tensile strength and thermal conductivity in a highly-heat generating and high temperature environments.

An embodiment of the present invention provides a carbon fiber reinforced composite structure comprising: a plurality of carbon fiber reinforced sheets, which are laminated; and a stitch member penetrating one or more carbon fiber reinforced sheets, wherein the carbon fiber reinforced sheet includes a plurality of reinforcing carbon fibers arranged in one direction.

In an exemplary embodiment, adjacent carbon fiber reinforced sheets may have different arrangement directions of the reinforcing carbon fiber.

In an exemplary embodiment, adjacent carbon fiber reinforced sheets may be laminated with the reinforcing carbon fibers arranged at an angle of 90°.

In an exemplary embodiment, the carbon fiber reinforced sheet may be a prepreg, and the prepreg may include a plurality of reinforcing carbon fibers arranged in one direction and a polymer resin impregnated with the reinforcing carbon fibers.

In an exemplary embodiment, the stitch member may include one or more selected from the group consisting of a PAN-based carbon fibers, a pitch-based carbon fibers, and a boron nitride (BN) fibers.

In an exemplary embodiment, the reinforcing carbon fiber may include a PAN-based carbon fiber, and the stitch member may include a pitch-based carbon fiber.

In an exemplary embodiment, the reinforcing carbon fiber and the stitch member may have a coefficient of thermal expansion within a range of −1×10⁻⁶ to 1×10⁻⁶ K⁻¹.

In an exemplary embodiment, the stitch member may transmit heat in a thickness direction of the carbon fiber reinforced sheet.

Another embodiment of the present invention provides a method for producing a carbon fiber reinforced composite structure, the method including: i) laminating a plurality of carbon fiber reinforced sheets; ii) penetrating one or more of the laminated carbon fiber reinforced sheets with a stitch member; and iii) forming a carbon fiber composite structure by molding and curing the laminated carbon fiber reinforced sheets, in which the carbon reinforced sheet includes a plurality of reinforcing carbon fibers arranged in one direction.

In an exemplary embodiment, the i) laminating of the carbon fiber reinforced sheets may laminate the reinforcing carbon fibers of adjacent carbon fiber reinforced sheets in different arrangement directions.

In an exemplary embodiment, the carbon fiber reinforced sheet may be a prepreg, and the prepreg may include a plurality of reinforcing carbon fibers arranged in one direction and a polymer resin impregnated with the reinforcing carbon fibers.

In an exemplary embodiment, the reinforcing carbon fiber may include a PAN-based carbon fiber, and the stitch member may include a pitch-based carbon fiber.

In an exemplary embodiment, the ii) penetrating of the stitch member may include penetrating a stitch needle including the stitch member, and removing the stitch needle.

In an exemplary embodiment, the stitch needle may include a body including a through-hole formed in a longitudinal direction therein; and a stitch member disposed in the through-hole, and one end portion of the body may have an inclined surface.

In an exemplary embodiment, the inclined surface may form an angle of 50 to 80° with the body.

In an exemplary embodiment, the molding and curing may include a process by an autoclave (AC), an oven molding (semi prepreg, Resin Film Infusion), Filament Winding (FW), Resin Transfer Molding (RTM), Vacuum assisted RTM (VaRTM), Prepreg Compression Molding (PCM), or an injection molding.

In an exemplary embodiment, the molding and curing may be performed at a temperature of 50 to 150° C. for 10 to 120 minutes.

### BRIEF DESCRIPTION OF THE DRAWINGS

FIG. 1 illustrates a schematic view of a carbon fiber reinforced composite structure according to an embodiment of the present invention;

FIG. 2A to 2G illustrates a process of stitching a stitch member to a laminated carbon fiber reinforced sheet in a carbon fiber reinforced composite structure according to an embodiment of the present invention;

FIGS. 3A and 3B indicate the positions where a stitch member is allowed to penetrate the back surface of a laminated carbon fiber reinforced sheet (FIG. 3A) and illustrate a photograph of the sample specimens of the Examples and the Comparative Examples produced through this (FIG. 3B); and

FIG. 4 illustrates a flowchart of a method for producing a carbon fiber reinforced composite structure according to an embodiment of the present invention.

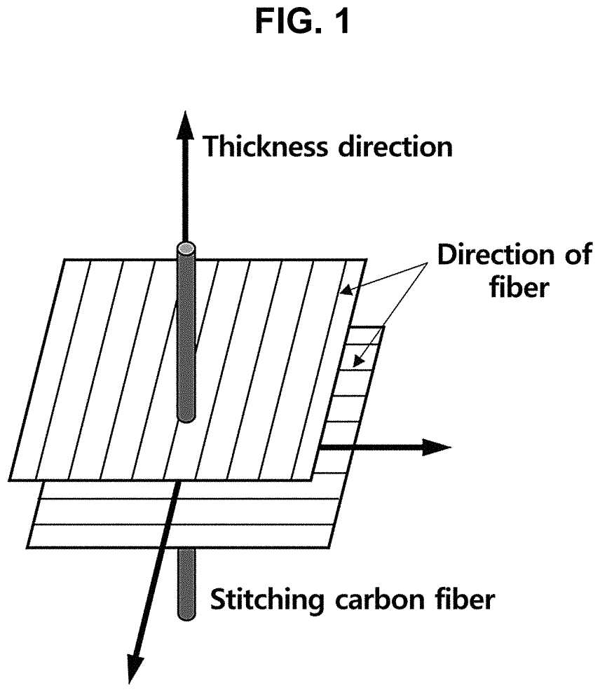

### DETAILED DESCRIPTION OF THE PREFERRED EMBODIMENTS

Hereinafter, preferred examples of the present invention will be described in detail with reference to the accompanying drawings.

The examples of the present invention disclosed herein are exemplified for the purpose of describing the examples of the present invention only, and the examples of the present invention may be carried out in various forms and should not be construed to be limited to the examples described herein.

Since the present invention may have various changes and different forms, it should be understood that the Examples are not intended to limit the present invention to specific disclosure forms and they include all the changes, equivalents and replacements included in the spirit and technical scope of the present invention.

Singular expressions include plural expressions unless the singular expressions have definitely opposite meanings in the context. In the present application, it will be appreciated that the term “include” or “have” is intended to designate the existence of characteristics, numbers, steps, operations, constituent elements, and parts described in the specification or a combination thereof, and does not exclude in advance a possibility of the existence or addition of one or more other characteristics, numbers, steps, operations, constituent elements, and parts, or a combination thereof.

As used herein, the term “stitch” refers to allowing a reinforcing fiber in the form of a tow to penetrate a fiber reinforced sheet and integrally reinforcing the fiber reinforced sheet and the reinforcing fiber.

As used herein, the term “coefficient of thermal expansion” refers to the change in length of expansion of any object whenever the temperature is increased by 1° C. when heat is applied to the object.

Fiber Reinforced Composite Structure

In an embodiment of the present invention, provided is a fiber reinforced composite structure comprising: a plurality of fiber reinforced sheets, which are laminated; and a stitch member penetrating one or more fiber reinforced sheets, in which the fiber reinforced sheet includes a plurality of reinforcing fibers arranged in one direction.

In an embodiment, the reinforcing fiber of the fiber reinforced sheet may be a reinforcing cellulose fiber, a reinforcing glass fiber, or a reinforcing carbon fiber, and for example, the fiber reinforced sheet may be a carbon fiber reinforced sheet. In general, it is known that carbon fiber reinforced polymer (CFRP) composite materials have various physical properties such as Young's modulus, Poisson's ratio, and shear modulus, which are remarkably higher than those of glass fiber reinforced polymer (GFRP) composite materials, and specifically, the CFRP is excellent in terms of Young's modulus, Poisson's ratio, and shear modulus as compared to the GFRP. In particular, it is understood that the ultimate stress of a carbon fiber reinforced composite material is approximately 6 to 10 times higher than that of an epoxy composite material made of glass fiber on the basis of 35° C. Furthermore, it is known that when a flexural test to measure the bending strength is performed (FIG. 5), the ultimate stress of the CFRP is 4 times or higher than the stress value of the GFRP. Accordingly, the carbon fiber reinforced composite structure according to the present invention may have excellent physical properties as compared to composite materials of different materials, for example, glass fibers, and the like.

In an embodiment, adjacent fiber reinforced sheets may have reinforcing fibers arranged in the same direction or different directions. Specifically, when the reinforcing fibers between adjacent fiber reinforced sheets are arranged in the same direction, that is, when the reinforcing fibers between adjacent fiber reinforced sheets are arranged in a unidirectional (UD) direction, lateral rigidity may be weak, whereas the reinforcing fibers may have excellent strength characteristics in one direction. Further, specifically, when the reinforcing fibers between adjacent fiber reinforced sheets are arranged in different directions, that is, in the reinforcing fibers arranged in one direction in the fiber reinforced sheet, physical properties may be improved by allowing adjacent sheets to be arranged in different directions.

For example, adjacent fiber reinforced sheets may be laminated by setting the arrangement direction of the reinforcing fibers at 0°, 45°, or 90°, and preferably, adjacent fiber reinforced sheets may be laminated by setting the arrangement direction of the reinforcing fibers at 90°.

In an embodiment, the thicknesses of the plurality of fiber reinforced sheets may have different number of layers depending on the applied thickness. For example, the plurality of fiber reinforced sheets may be laminated as two or more layers. When the fiber reinforced sheets are laminated as less than two layers, it may be difficult to improve physical properties because the reinforcing fibers arranged in one direction cannot be laminated having the adjacent sheets arranged in different directions.

In an embodiment, the fiber reinforced sheet may include reinforcing fibers, and the reinforcing fiber may be woven or non-woven reinforcing fibers. Specifically, the woven reinforcing fiber may include woven carbon fibers, such as unidirectional (UD) woven fabric, NCF, plain weave, twill weave, silk weave, and basket structures.

In an embodiment, the reinforcing fiber may be a reinforcing carbon fiber, and further, the reinforcing carbon fiber may include a PAN-based carbon fiber or a pitch-based carbon fiber. Preferably, the reinforcing carbon fiber included in the fiber reinforced sheet may include a PAN-based carbon fiber, and since the PAN-based carbon fiber has a tensile strength of about 1.5 times (about 6400 MPa), it is possible to obtain excellent physical properties.

In an embodiment, the carbon fiber reinforced sheet may be a prepreg, and the prepreg may include a plurality of reinforcing carbon fibers arranged in one direction and a polymer resin impregnated with the reinforcing carbon fibers.

In an embodiment, the polymer resin may include an epoxy resin or a urethane resin. The polymer resin may be cured by a polymerization reaction to form a matrix in a carbon material sheet. For example, the polymer resin may include a thermosetting resin, a thermoplastic resin, and a condensation resin, the thermosetting resin may include bisphenol type, novolak type, aromatic amine type, alicyclic epoxy resin, and the like, the thermoplastic resin may include nylon, polycarbonate, polysulfone, polyester sulfone, polyester ester ketone (PEEK), and the like, and the condensation resin may include a polyester resin, a vinyl ester resin, and the like.

In an embodiment, the stitch member may penetrate a fiber reinforced sheet, and a fiber reinforced composite structure may include one or more stitch members. Specifically, a plurality of stitch members may independently penetrate a fiber reinforced sheet, and for example, one stitch member may penetrate laminated fiber reinforced sheets, and the other stitch members may penetrate independently laminated fiber reinforced sheets. In an embodiment, the stitch member may consist of a plurality of reinforcing carbon fibers, for example, thousands of strands of reinforcing carbon fibers, and the stitch member may include one or more selected from the group consisting of a PAN-based carbon fiber, a pitch-based carbon fiber, and a boron nitride (BN) fiber. Preferably, the stitch member may be a pitch-based carbon fiber, and since the pitch-based carbon fiber has a high elastic modulus (about 900 GPa), a high thermal conductivity (about 900 W/mK), and a low coefficient of thermal expansion, the pitch-based carbon fiber may have excellent thermal conductivity while strengthening the internal structure of the fiber reinforced composite structure or having excellent physical properties, so that it is possible to effectively transmit heat in a thickness direction of the fiber reinforced composite structure.

In an embodiment, the reinforcing carbon fiber and the stitch member may have a coefficient of thermal expansion within a range of −1×10⁻⁶ to 1×10⁻⁶ K⁻¹. In particular, the lower the coefficient of thermal expansion is, the less the deformation due to heat may be, and a target may stably maintain the original shape thereof in an environment where the temperature change is large. Table 1 below shows the coefficients of thermal expansion of reinforcing carbon fibers and epoxies, and Table 2 below shows the coefficients of thermal expansion of the carbon fiber composites produced therefrom.

TABLE 1

| CTE (Fibers, Epoxy) | (×10⁶/° F.) | (×10⁶/° C.) |
|---|---|---|
| PAN-based carbon fiber (T50) | −0.5 | −0.9 |
| Pitch-based carbon fiber (P55) | −0.7 | −1.26 |
| Pitch-based carbon fiber (P75) | −0.75 | −1.35 |
| Pitch-based carbon fiber (P120) | −0.8 | −1.44 |
| Epoxy (Fiberite 934) | 28 | 50.4 |
| Reinforced epoxy (ERL1962) | 24 | 43.2 |
| Cyanate Ester (YLA RS3) | 31.5 | 56.7 |

TABLE 2

| CTE (Composites) | (×10⁶,/° F.) | (×10⁶,/° C.) |
|---|---|---|
| T50/ERL1962 | −0.305 | −0.549 |
| P55/ERL1952 | −0.385 | −0.693 |
| P75/ERL1962 | −0.501 | −0.9018 |
| P120/ERL1962 | −0.675 | −1.215 |
| P75/934 | −0.652 | −1.1736 |
| P75/RS3 | −0.662 | −1.1916 |

From the coefficient values of thermal expansion in Tables 1 and 2, it can be seen that glass fibers consisting of E-glass have a coefficient of thermal expansion of 4.7 to 5×10⁻⁶ (K⁻¹) and GFRP composite materials made of reinforcing glass fibers have a coefficient of thermal expansion of 15 to 25×10⁻⁶ (K⁻¹), whereas carbon fibers have a coefficient of thermal expansion of −0.9 to −0.5×10⁻⁶ (K⁻¹) and the CFRP composite materials made of reinforcing carbon fibers have a coefficient of thermal expansion of −1 to 1×10⁻⁶ (K⁻¹), which are rarely thermally expanded.

Further, the stitch member may include a PAN-based carbon fiber or a pitch-based carbon fiber, and may have a coefficient of thermal expansion within a range of −1×10⁻⁶ to 1×10⁻⁶ K⁻¹. It is known that MWCNT used as a general reinforcing material has a coefficient of thermal expansion of 16 to 26×10⁻⁶ (K⁻¹), and copper has a coefficient of thermal expansion of 17×10⁻⁶ (K⁻¹), and in particular, the fiber reinforced composite structure according to the present invention may be advantageous in terms of coefficient of thermal expansion as compared to composite materials using glass fibers, copper wires, CNT yarns, and the like (similar to the coefficient of thermal expansion of CNT) as a reinforcing material.

Meanwhile, GFRP itself has a difference in coefficient of thermal coefficient by about 20 times as compared to that of CFRP, and in addition, the change in length/volume due to temperature may be very small when GFRP includes a carbon fiber reinforced sheet including reinforcing carbon fibers and one or more selected from the group consisting of a PAN-based carbon fiber, a pitch-based carbon fiber, and a boron nitride (BN) fiber as a stitch member penetrating the carbon fiber sheet as compared to when copper or CNT yarn having a large coefficient of thermal expansion is stitched as a reinforcing material, and for example, there may be little change in length/volume.

Accordingly, the fiber reinforced composite structure of the present invention has a long lifetime because the change in length or volume is not large even in an environment with a large temperature change (desert, space out of the atmosphere, and the like). Accordingly, the fiber reinforced composite structure of the present invention has a longer lifetime than the related art, and may be applied as a material for an artificial satellite structure, a sandwich panel, or the like.

In an embodiment, the reinforcing carbon fiber may include a PAN-based carbon fiber, and the stitch member may include a pitch-based carbon fiber.

Accordingly, a reinforcing carbon fiber in a planar direction may include a PAN-based carbon fiber and a stitch member in a thickness direction may include a pitch-based combination, so that it is possible to constitute a carbon fiber reinforced composite material having high tensile strength and high thermal conductivity in a thickness direction as compared to carbon fiber reinforced composite materials in the related art.

In particular, the fiber composite structure according to the present invention may allow a fiber reinforced sheet to penetrate a stitch member consisting of at least several thousands of strands of carbon fibers instead of CNT, nanocarbon fibers, conductors or metal fibers/wires in a thickness direction using a stitch needle in addition to a fiber reinforced composite material laminate formed by a lamination method, and it is possible to improve the thermal conductivity in a thickness direction, that is, a lamination direction of the fiber composite structure by such a differential stitching technique.

In an embodiment, the stitch member may transmit heat in a thickness direction of the carbon fiber reinforced sheet.

Method for Producing Fiber Reinforced Composite Structure

An embodiment of the present invention provides a method for producing a fiber reinforced composite structure, the method comprising: i) laminating a plurality of fiber reinforced sheets; ii) penetrating one or more of the laminated fiber reinforced sheets with a stitch member; and iii) forming a fiber reinforced composite structure by molding and curing the laminated fiber reinforced sheets, in which the fiber reinforced sheet includes a plurality of reinforcing fibers arranged in one direction. In the present production method, the specific characteristics of the fiber reinforced composite structure are the same as those described above, and will not be described again.

In an embodiment, the fiber reinforced sheet may be a carbon fiber reinforced sheet.

In an embodiment, the i) laminating of the fiber reinforced sheets may laminate the reinforcing fiber of adjacent fiber reinforced sheets in different arrangement directions.

In an embodiment, the fiber reinforced sheet may be a prepreg, and the prepreg may include a plurality of reinforcing fibers arranged in one direction and a polymer resin impregnated with the reinforcing fibers.

Specific characteristics of the carbon fiber reinforced sheet and the stitch member are the same as those described above.

In an embodiment, the reinforcing carbon fiber may include a PAN-based carbon fiber, and the stitch member may include a pitch-based carbon fiber. Accordingly, a reinforcing carbon fiber in a planar direction includes a PAN-based fiber and a stitch member in a thickness direction includes a pitch-based combination, so that it is possible to constitute a carbon fiber reinforced composite material having high tensile strength and high thermal conductivity in a thickness direction as compared to carbon fiber reinforced composite materials in the related art.

In an embodiment, the ii) penetrating of the stitch member may include penetrating a stitch needle including the stitch member, and removing the stitch needle. For example, the ii) penetrating of the stitch member may include penetrating the stitch needle including the stitch member and removing only the stitch needle while penetrating the stitch member as it is. By such a method, it is possible to produce a fiber reinforced composite structure by minimizing damage to the reinforcing fibers and performing a simple process without an additional process of passing the reinforcing fibers through the stitch needle.

In an embodiment, the stitch needle may include a body including a through-hole formed in a longitudinal direction therein; and a stitch member disposed in the through-hole, and one end portion of the body may have an inclined surface.

In an embodiment, the inclined surface may form an angle with the body, and for example, the inclined surface may form an angle of 50 to 80° with the body. Within an angle range of 50 to 80°, fibers can be protected and the sharpness enough to penetrate the fiber reinforced sheet can be maintained.

In addition, the diameter of the stitch needle may vary depending on the diameter of the stitch member, and specifically, the diameter of the stitch needle may be 10 to 20 gauge or 13 to 16 gauge. For example, the stitch needle may be 13 gauge (an inner diameter of about 2.03 mm, an outer diameter of about 2.40 mm) or 16 gauge (an inner diameter of about 1.27 mm, an outer diameter of about 1.66 mm)

The stitch needle may include a stitch member in a through-hole formed in a longitudinal direction therein, and thus, the stitch needle may protect the stitch member when penetrating the fiber reinforced composite structure. Accordingly, the stitch member and the stitch needle can penetrate the fiber reinforced composite structure as it is, and the stitch member may not be damaged by friction.

In contrast, the conventional stitching method used a method of cutting the fiber after the needle and the fiber are penetrated directly at the time of stitching the fiber, and such a method needs an additional process of passing the fiber through the needle again because the stitch member must penetrate the needle through which the fiber passes after stitching is once performed.

Accordingly, the method for producing a fiber reinforced composite structure according to the present invention may be a simple process without an additional process of passing a reinforcing fiber through the stitch needle again by including allowing a stitch needle including a stitch member to penetrate the fiber reinforced sheet and removing the stitch needle from the fiber reinforced sheet, and a fiber reinforced composite structure produced by minimizing damage to the reinforcing fibers may have excellent physical properties.

In an embodiment, the molding may include a process by an autoclave (AC), an oven molding (such as semi prepreg, Resin Film Infusion), Filament Winding (FW), Resin Transfer Molding (RTM), Vacuum assisted RTM (VaRTM), Prepreg Compression Molding (PCM), or an injection molding.

In an embodiment, the molding and curing may be performed at a temperature of 50 to 150° C. for 10 to 120 minutes. When the temperature is lower than 50° C., the specimen may not be completed because no curing occurs, and when the temperature is higher than 150° C., discoloration and browning of the resin, ignition of the resin, deterioration in mechanical properties, and the like may occur. Furthermore, when the time is less than 10 minutes, physical properties may sharply deteriorate and the specimen may not be completed because the curing does not sufficiently occur, and when the time is more than 120 minutes, a phenomenon such as discoloration of the resin and deterioration in mechanical strength may occur.

### EXAMPLES

Hereinafter, the present invention will be described in more detail through Examples. These Examples are only for exemplifying the present invention, and it should be obvious to a person with ordinary skill in the art that the scope of the present invention is not interpreted as being limited by these Examples.

### Comparative Example 1: Carbon Fiber Reinforced Structure

A prepreg (USN200A, SK chemicals) containing a PAN-based carbon fiber was cut into a shape of a square having a width of 8 cm and a length of 8 cm in a direction perpendicular and parallel to the fiber direction. 22 layers were laminated by turning the prepreg pieces at 0° for odd-numbered layers and 90° for even-numbered layers to make the directions of fibers of adjacent layer perpendicular to each other, thereby producing a fiber reinforced structure.

### Example 1: Fiber Reinforced Composite Structure (One-Time Stitch, PAN-Based)

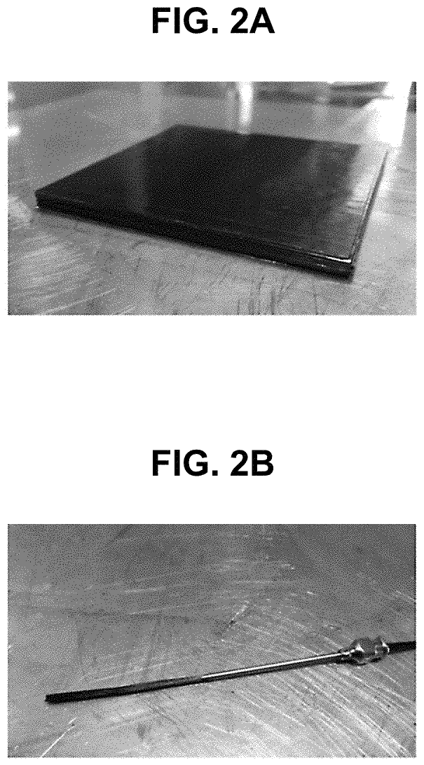

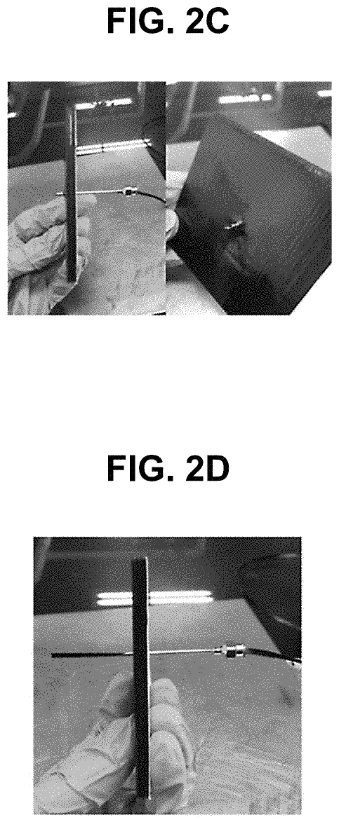

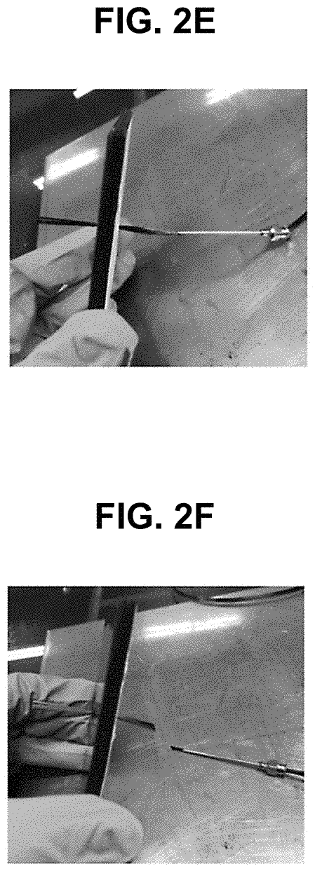

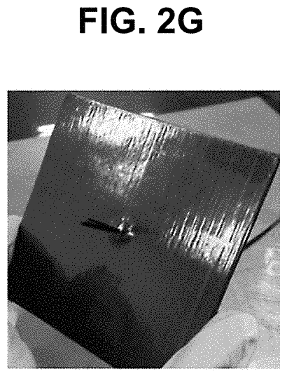

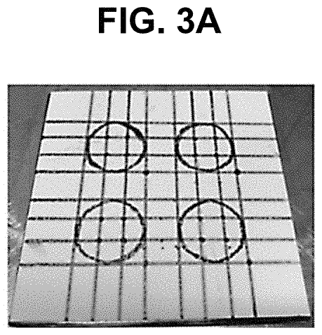

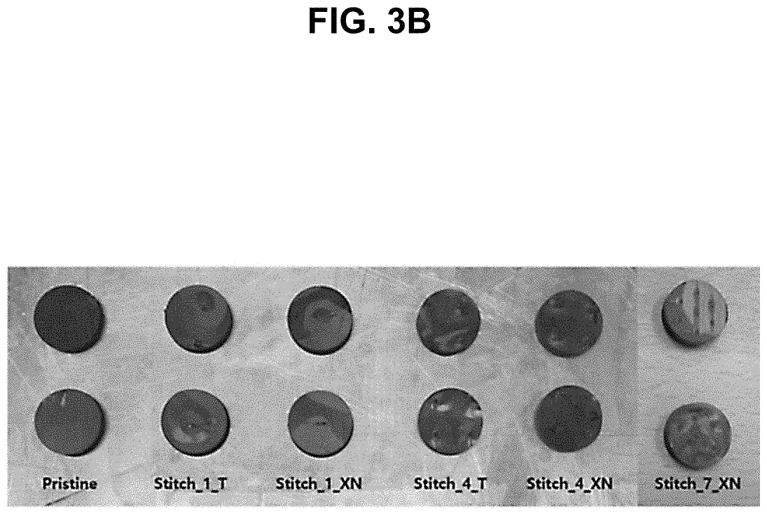

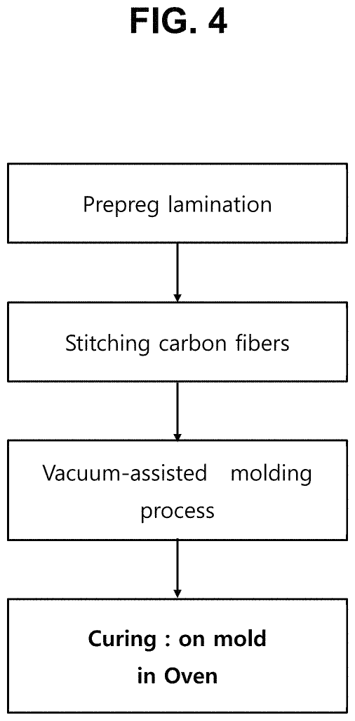

A prepreg (USN200A, SK chemicals) containing a PAN-based carbon fiber was cut into a shape of a square having a width of 8 cm and a length of 8 cm in a direction perpendicular and parallel to the fiber direction. 22 layers were laminated by turning the prepreg pieces at 0° for odd-numbered layers and 90° for even-numbered layers to make the directions of fibers of adjacent layer perpendicular to each other, thereby producing a fiber reinforced structure. And then, a PAN-based carbon fiber (T700, TORAY Industries, Inc.) was allowed to penetrate a stitch needle having a predetermined thickness, and the needle was used to stitch one point inside a circle having a diameter of 19 mm in the fiber reinforced structure. After the penetrated needle tip was sufficiently placed upward, the fiber was taken out so that the fiber penetrates the prepreg (FIGS. 2C and 2D). After penetrating the fiber, the needle that had penetrated the prepreg was again taken out while taking care so that the fiber did not fall again with the needle (FIG. 2E). The inserted fiber was cut off leaving front and rear margins to prevent detachment. Thereafter, the fibers were molded and cured at 80° C. for 30 minutes and 125° C. for 90 minutes by a prepreg molding process using vacuum, thereby producing a fiber reinforced composite structure.

### Example 2: Fiber Reinforced Composite Structure (One-Time Stitch, Pitch-Based)

A fiber reinforced composite structure was produced in the same manner as in Example 1, except that a pitch-based carbon fiber (XN-90-60S, NGF) was used as the carbon fiber penetrating and stitching the fiber reinforced structure.

### Example 3: Fiber Reinforced Composite Structure (Four-Time Stitches, PAN-Based)

A fiber reinforced composite structure was produced in the same manner as in Example 1, except that the needle was used to stitch four points inside a circle having a diameter of 19 mm in the fiber reinforced structure.

### Example 4: Fiber Reinforced Composite Structure (Four-Time Stitches, Pitch-Based)

A fiber reinforced composite structure was produced in the same manner as in Example 2, except that the needle was used to stitch four points inside a circle having a diameter of 19 mm in the fiber reinforced structure.

### Example 5: Fiber Reinforced Composite Structure (Seven-Time Stitches, Pitch-Based)

A fiber reinforced composite structure was produced in the same manner as in Example 2, except that the needle was used to stitch seven points inside a circle having a diameter of 19 mm in the fiber reinforced structure.

### Experimental Example 1. Thermal Conductivity Analysis

In order to understand the thermal conductivities in a thickness direction of the fiber reinforced composite structures of Comparative Example 1 and Examples 1 to 5, a hot disk method thermal property measuring device was used. Table 3 shows the thermal conductivity test conditions.

TABLE 3

Heat diffusivity
Specimen: Cylinder Φ 19 mm × 3 to 5 mm
Measuring time: 1 to 30 s
Input power: 50 to 250 mW
Specific heat
Specimen: Cylinder Φ 19 mm × 3 to 5 mm
Measuring time: 5 to 120 s
Input power: 50 to 250 mW

Through this analysis, the thermal properties such as the thermal diffusivity, specific heat, and thermal conductivity of the fiber reinforced composite structures of Comparative Examples and Examples were understood. And then, through the measured specific heat and thermal diffusivity, the thermal conductivity was calculated, and the thermal diffusivities and calculated thermal conductivities are shown in Table 4.

TABLE 4

| | | Axial | | Radial |
|---|---|---|---|---|
| | Axial | thermal | Radial | thermal |
| | thermal | conduc- | thermal | conduc- |
| | diffusivity | tivity | diffusivity | tivity |
| Sample | (m²/s) | (W/mK) | (m²/s) | (W/mK) |
| Comparative | 6.945 × 10⁻⁷ | 1.000 | 1.878 × 10⁻⁶ | 2.705 |
| Example 1 | | | | |
| (Pristine) | | | | |
| Example 1 | 7.975 × 10⁻⁷ | 1.172 | 2.112 × 10⁻⁶ | 3.103 |
| (Stitch_1_T) | | | | |
| Example 2 | 1.041 × 10⁻⁶ | 1.615 | 2.343 × 10⁻⁶ | 3.635 |
| (Stitch_1_XN) | | | | |
| Example 3 | 1.079 × 10⁻⁶ | 1.705 | 1.905 × 10⁻⁶ | 3.010 |
| (Stitch_4_T) | | | | |
| Example 4 | 1.019 × 10⁻⁶ | 1.649 | 1.863 × 10⁻⁶ | 3.014 |
| (Stitch_4_XN) | | | | |
| Example 5 | 1.439 × 10⁻⁶ | 2.226 | 2.104 × 10⁻⁶ | 3.256 |
| (Stitch_7_XN) | | | | |

As a result of measuring thermal diffusivities, the thermal diffusivity values in a thickness direction in Example 1 (Stitch_1_T) and Example 2 (Stitch_1_XN) were increased by about 14.8% and about 49.9%, respectively, as compared to Comparative Example 1 in which the fiber reinforced composite structure was not stitched. When the thermal conductivities were calculated, the thermal conductivity values in a thickness direction in Example 1 (Stitch_1_T) and Example 2 (Stitch_1_XN) were increased by about 17.2% and about 61.5%, respectively, as compared to Comparative Example 1 in which the fiber reinforced composite structure was not stitched. The rate of increase in thermal conductivity was greater than the rate of increase in thermal diffusivity because the specific heat capacities of the Examples were multiplied. Although the rate did not tend to be linearly increased, it was shown that the specific heat capacity was usually increased when the stitch member was included. In addition, the thermal conductivity value of Example 2 (Stitch_1_XN) was about 37% higher than that of Example 1 (Stitch_1_T). This is due to the difference in thermal conductivity values of the carbon fibers themselves used as the stitch members.

Furthermore, in Example 3 (Stitch_4_T) and Example 4 (Stitch_4_XN) in which four points were stitched, the rate of increase in thermal diffusivity was improved by 55.4% and 46.8%, respectively, and the thermal conductivity in a thickness direction was improved by 70.5% and 64.9%, respectively, as compared to Comparative Example 1 (Pristine). In Example 5 (Stitch_7_XN) in which seven points were stitched, the thermal diffusivity and thermal conductivity were increased by 107.1% and 122.6%, respectively, as compared to those of Comparative Example 1 (Pristine), so that Example 5 (Stitch_7_XN) showed the highest value in the rate of increase among all the examples.

It can be seen that the thermal conductivity values of Example 1 (Stitch_1_T) and Example 3 (Stitch_4_T) in which the PAN-based carbon fiber was used as the stitch member were dramatically increased to 1.172 and 1.705 (W/mK), respectively. The thermal conductivity values of Example 2 (Stitch_1_XN), Example 4 (Stitch_4_XN), and Example 5 (Stitch_7_XN) in which the pitch-based carbon fiber was used as the stitch member were 1.615, 1.649, and 2.226 (W/mK), respectively, so that it could be seen that even though only one point was stitched, the thermal conductivity was increased by 61% or more as compared to that of Comparative Example 1 (Pristine).

The Examples of the present invention previously described should not be interpreted to limit the technical spirit of the present invention. The scope of the present invention to be protected is limited only by the matters described in the claims, and those skilled in the art of the present invention can improve and change the technical spirit of the present invention in various forms. Therefore, such improvements and changes would fall within the scope of the present invention to be protected as long as they are obvious to those skilled in the art.

The fiber composite structure according to embodiments of the present invention can have excellent thermal conductivity in which the thermal conductivity is increased by about 120% or more in a thickness direction.

Further, the fiber composite structure according to embodiments of the present invention is a fiber reinforced composite material (FRP) having excellent tensile strength and can be applied to various fields such as the aerospace, automotive, sports and leisure industries.

In addition, the method for producing a fiber composite structure according to embodiments of the present invention presents a stitch method capable of minimizing damage to the reinforcing fiber, and may be a simple process without an additional process of passing the reinforcing fiber through the stitch needle again.

While the present invention has been described with respect to the specific embodiments, it will be apparent to those skilled in the art that various changes and modifications may be made without departing from the spirit and scope of the invention as defined in the following claims.

What is claimed is:

1. A carbon fiber reinforced composite structure comprising: a plurality of carbon fiber reinforced sheets, which are laminated; and a stitch member penetrating one or more carbon reinforced fiber sheets,
wherein the carbon fiber reinforced sheet comprises a plurality of reinforcing carbon fibers arranged in one direction.

2. The carbon fiber reinforced composite structure of claim 1, wherein adjacent carbon fiber reinforced sheets have different arrangement directions of the reinforcing carbon fiber.

3. The carbon fiber reinforced composite structure of claim 2, wherein adjacent carbon fiber reinforced sheets are laminated with the reinforcing carbon fibers arranged at an angle of 90°.

4. The carbon fiber reinforced composite structure of claim 1, wherein the carbon fiber reinforced sheet is a prepreg, and the prepreg comprises a plurality of reinforcing carbon fibers arranged in one direction and a polymer resin impregnated with the reinforcing carbon fibers.

5. The carbon fiber reinforced composite structure of claim 1, wherein the stitch member comprises one or more selected from the group consisting of a PAN-based carbon fibers, a pitch-based carbon fibers, and a boron nitride (BN) fibers.

6. The carbon fiber reinforced composite structure of claim 1, wherein the reinforcing carbon fiber comprises a PAN-based carbon fiber, and the stitch member comprises a pitch-based carbon fiber.

7. The carbon fiber reinforced composite structure of claim 1, wherein the reinforcing carbon fiber and the stitch member have a coefficient of thermal expansion within a range of −1×10⁻⁶ to 1×10⁻⁶ K⁻¹.

8. The carbon fiber reinforced composite structure of claim 1, wherein the stitch member transmits heat in a thickness direction of the carbon fiber reinforced sheet.

9. A method for producing a carbon fiber reinforced composite structure, the method comprising:
i) laminating a plurality of carbon fiber reinforced sheets;
ii) penetrating one or more of the laminated carbon fiber reinforced sheets with a stitch member; and
iii) forming a carbon fiber reinforced composite structure by molding and curing the laminated carbon fiber reinforced sheets,
wherein the carbon fiber reinforced sheet comprises a plurality of reinforcing carbon fibers arranged in one direction.

10. The method of claim 9, wherein the i) laminating of the carbon fiber reinforced sheets laminates the reinforcing carbon fibers of adjacent carbon fiber reinforced sheets in different arrangement directions.

11. The method of claim 9, wherein the carbon fiber reinforced sheet is a prepreg, and the prepreg comprises a plurality of reinforcing carbon fibers arranged in one direction and a polymer resin impregnated with the reinforcing carbon fibers.

12. The method of claim 9, wherein the reinforcing carbon fiber comprises a PAN-based carbon fiber, and the stitch member comprises a pitch-based carbon fiber.

13. The method of claim 9, wherein the ii) penetrating of the stitch member comprises penetrating a stitch needle comprising the stitch member, and removing the stitch needle.

14. The method of claim 13, wherein the stitch needle comprises a body comprising a through-hole formed in a longitudinal direction therein; and a stitch member disposed in the through-hole, and one end portion of the body has an inclined surface.

15. The method of claim 14, wherein the inclined surface forms an angle of 50 to 80° with the body.

16. The method of claim 9, wherein the molding and curing comprises a process by an autoclave (AC), an oven molding, Filament Winding (FW), Resin Transfer Molding (RTM), Vacuum assisted RTM (VaRTM), Prepreg Compression Molding (PCM), or an injection molding.

17. The method of claim 9, wherein the molding and curing is performed at a temperature of 50 to 150° C. for 10 to 120 minutes.
